(19) United States
(12) Patent Application Publication
(10) Pub. No.: US 2026/0103057 A1
(43) Pub. Date: Apr. 16, 2026

(54) VEHICLE VISOR ASSEMBLY INCORPORATING DISPLAY

(71) Applicant: GM GLOBAL TECHNOLOGY OPERATIONS LLC, Detroit, MI (US)

(72) Inventors: Homin Cha, Seoul (KR); Kwangyoung Kim, Incheon (KR); Seokju Yong, Bucheon-si (KR); Hyojin Lee, Seoul (KR); Minhyung Kang, Bucheon-si (KR)

(73) Assignee: GM GLOBAL TECHNOLOGY OPERATIONS LLC, Detroit, MI (US)

(21) Appl. No.: 18/912,793

(22) Filed: Oct. 11, 2024

(51) Int. Cl. B60J 3/02; B60K 35/10; B60K 35/22; B60K 35/29

(52) U.S. Cl. CPC B60J 3/0252; B60J 3/0278; B60K 35/10; B60K 35/22; B60K 35/29

(57) ABSTRACT

A visor assembly includes a mounting assembly having a base portion and an arm extending from the base portion and a body portion rotatably attached to the arm of the mounting assembly having a first side located opposite a second side. The assembly also includes a display located adjacent to one of the first side or the second side of the body portion and a sensor assembly configured to determine a position of the body portion relative to the mounting assembly. The assembly also includes a controller in communication with the display and the sensor assembly. The controller is configured to determine a message to display on the display, determine a position of the body portion relative to the mounting assembly with the sensor assembly, and display the message on the display in a predetermined orientation based on the position of the body portion relative to the mounting assembly.

### BACKGROUND

The present disclosure related to a visor assembly, and more particularly, to a visor assembly for a vehicle passenger cabin.

Vehicle passenger cabins are accessed by occupants through access openings that are selectively accessed through vehicle doors that are movable between an open position allowing ingress and egress and a closed position preventing ingress or egress. When inside the vehicle passenger cabin, visor assemblies may be located adjacent to the windshield to selectively block light from entering to improve passenger visibility. The visor assemblies may also include a mirror on one side that is viewable by one or more of the passengers.

### SUMMARY

Disclosed herein is a visor assembly. The assembly includes a mounting assembly having a base portion and an arm extending from the base portion and a body portion rotatably attached to the arm of the mounting assembly having a first side located opposite a second side. The assembly also includes a display located adjacent to one of the first side or the second side of the body portion and a sensor assembly configured to determine a position of the body portion relative to the mounting assembly. The assembly also includes a controller in communication with the display and the sensor assembly. The controller is configured to determine a message to display on the display, determine a position of the body portion relative to the mounting assembly with the sensor assembly, and display the message on the display in a predetermined orientation based on the position of the body portion relative to the mounting assembly.

In one aspect of the disclosure the assembly includes an input located on the body portion including a switch configured to activate the display and a dial configured to vary a brightness of the display.

In one aspect of the disclosure the controller is located within the body portion.

In one aspect of the disclosure the sensor assembly includes a hall sensor located on one of the body portion and the arm and an indicator located on the other of the body portion and the mounting assembly.

In one aspect of the disclosure the hall sensor is fixed relative to the body portion and the indicator is fixed relative to the arm.

In one aspect of the disclosure the indicator is cylindrical and includes a projection extending radially outward therefrom and at least a portion of the indicator is comprised of steel.

In one aspect of the disclosure the controller is configured to receive wireless signals from a mobile device to determine the message.

In one aspect of the disclosure the controller is configured to receive input signals from an infotainment system on a vehicle to determine the message.

In one aspect of the disclosure the display is a touchscreen display.

Disclosed herein is a vehicle. The vehicle includes a passenger cabin supported by a plurality of wheels and at least one visor assembly located within the passenger cabin. The visor assembly includes a mounting assembly having a base portion and an arm extending from the base portion and a body portion rotatably attached to the arm of the mounting assembly having a first side located opposite a second side. The assembly also includes a display located adjacent to one of the first side or the second side of the body portion and a sensor assembly configured to determine a position of the body portion relative to the mounting assembly. The assembly also includes a controller in communication with the display and the sensor assembly. The controller is configured to determine a message to display on the display, determine a position of the body portion relative to the mounting assembly with the sensor assembly, and display the message on the display in a predetermined orientation based on the position of the body portion relative to the mounting assembly.

In one aspect of the disclosure the assembly includes an input located on the body portion including a switch configured to activate the display and a dial configured to vary a brightness of the display.

In one aspect of the disclosure the controller is located within the body portion.

In one aspect of the disclosure the sensor assembly includes a hall sensor located on one of the body portion and the arm and an indicator located on the other of the body portion and the mounting assembly.

In one aspect of the disclosure the hall sensor is fixed relative to the body portion and the indicator is fixed relative to the arm.

In one aspect of the disclosure the controller is configured to receive wireless signals from a mobile device to determine the message.

In one aspect of the disclosure the controller is configured to receive input signals from an infotainment system on a vehicle to determine the message.

Disclosed herein is a method of operating a visor assembly of a vehicle. The method includes determining a message to display on a display of the visor assembly. The visor assembly includes a mounting assembly having a base portion and an arm extending from the base portion, a body portion rotatably attached to the arm with the body portion having a first side located opposite a second side and the display located on one of the first side or the second side. The visor assembly also includes a sensor assembly configured to determine a position of the body portion relative to the mount assembly. The method also includes determining a position of the body portion relative to the mounting assembly with the sensor assembly and displaying the message on the display in a predetermined orientation based on the position of the body portion relative to the mounting assembly.

In one aspect of the disclosure the method includes determining an operational state of the vehicle and activating the display based on the operational state of the vehicle.

In one aspect of the disclosure the method includes determining a battery voltage level of a vehicle battery and directing the display into an off mode when the battery voltage level is below a predetermined threshold battery voltage level.

In one aspect of the disclosure the method includes determining if a person is within a predetermined distance of the vehicle by identifying a person with a camera system on the vehicle, wherein the message is displayed on the display when the person is within the predetermined distance of the vehicle.

### BRIEF DESCRIPTION OF DRAWINGS

FIG. 1 schematically illustrates a vehicle having a pair of visor assemblies according to this disclosure.

FIG. 2 schematically illustrates one of the visor assemblies of FIG. 1.

FIG. 3 schematically illustrates one of the visor assemblies of FIG. 1 incorporated into the vehicle of FIG. 1.

FIG. 4 schematically illustrates a sensor assembly within one of the visor assemblies of FIG. 1.

FIG. 5 is a flow diagram of an example method of operating one of the visor assemblies of FIG. 1.

Some embodiments of the present disclosure are now described, by way of example only, and with reference to the accompanying drawings. The same reference number represents the same element or the same type of element in all drawings.

### DETAILED DESCRIPTION

Those having ordinary skill in the art will recognize that terms such as “above,” “below”, “upward”, “downward”, “top”, “bottom”, “left”, “right”, etc., are used descriptively for the figures, and do not represent limitations on the scope of the disclosure, as defined by the appended claims. Furthermore, the teachings may be described herein in terms of functional and/or logical block components and/or various processing steps.

When an operator of a vehicle leaves the vehicle, such as when parking, it can be desirable to leave a message with the vehicle. The message can convey information about when the operator will return or why the vehicle is parked in a given location. Additionally, it is desirable to obtain live status information regarding the vehicle, such as a battery charge level for electric vehicles. This disclosure is directed to a system and method for displaying user customizable information on a display on a visor assembly within a vehicle.

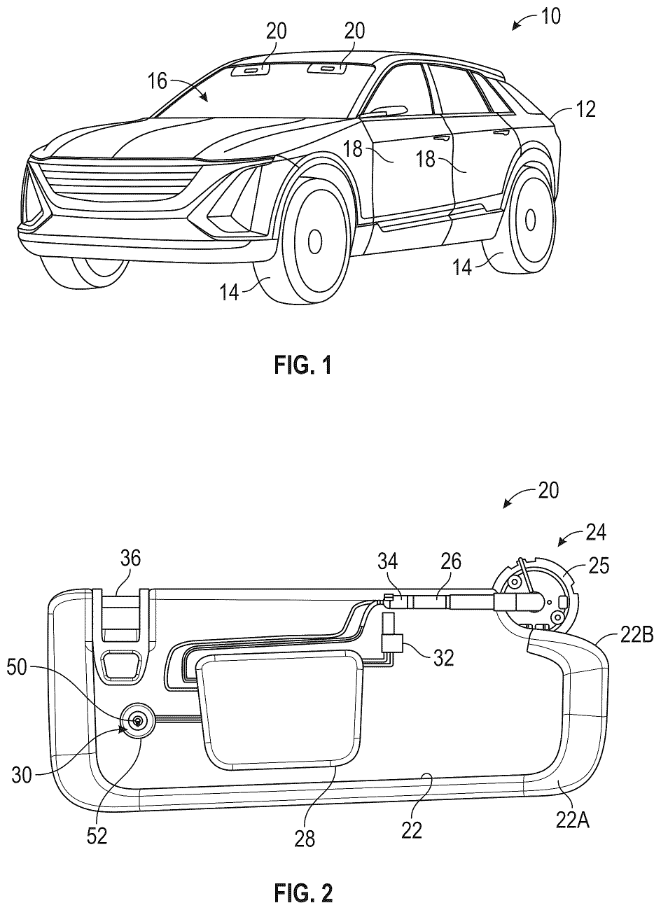

Referring to the FIGS., wherein like numerals indicate like parts referring to the drawings, wherein like reference numbers refer to like components, FIG. 1 is a schematic illustration of an example vehicle 10 including a vehicle body 12 supported by wheels 14. The vehicle body 12 at least partially defines a passenger cabin 16. The passenger cabin 16 is accessible through one of the vehicle doors 18 to allow for ingress and egress from the passenger cabin 16. At least one visor assembly 20 is located in the passenger cabin 16 and secured relative to the vehicle body 12.

FIG. 2 illustrates one of the visor assemblies 20 of FIG. 1 with each of the visor assemblies 20 being a mirror image of each other. In the illustrated example, the visor assembly 20 includes a body portion 22 having a first side 22A and a second side 22B opposite the first side 22A. The first and second sides 22A, 22B define a perimeter along an outer edge of the body portion 22. The visor assembly 20 is secured to the vehicle body 12 in the passenger cabin 16 by a mounting assembly 24. The mounting assembly 24 includes a base portion 25 for securing to the vehicle body 12 with fasteners and an arm 26 pivotably attached to the base portion 25 having an indicator 34 located at a distal end. The indicator 34, which can be at least partially comprised of steel and be cylindrical, includes a projection 56 that interfaces with a sensor 32, such as a hall sensor with magnetic poles. The body portion 22 is rotatable about the arm 26 between multiple positions depending on a location of a desired object, such as the sun, to be blocked from view of a driver or passenger of the vehicle 10. The body portion 22 can also pivot about the base portion 25 to further customize a location of the body portion 22 for the driver or passenger of the vehicle 10. A retainer 36 can interface with the passenger cabin 16 to secure the body portion 22 from pivoting outward about the base portion 25.

In the illustrated example, a display 28 is located adjacent to the first side 22A of the body portion 22 and a vanity mirror (not shown) can be located on the second side 22B of the body portion 22. The display 28 is positioned on the body portion 22 to allow a message to be visible to the driver or passenger within the passenger cabin 16 for a first predetermined range of rotational positions of the body portion 22 relative to the mounting assembly 24. Also, the display 28 can be visible to people outside of the vehicle 10 for a second predetermined range of rotational positions of the body portion 22 relative to the mounting assembly 24 as will be discussed in greater detail below.

An input 30 is located adjacent to the display 28 to allow a user to activate a power switch 50 and a dial 52 surrounding the power switch 50. As will be discussed in greater detail below, the input 30 is in electrical communication with the display 28 and/or a controller 40 for controlling various operations of the visor assembly 20. Furthermore, the dial 52 can operate a brightness dial to control a brightness level of the display. Alternatively, the dial 52 can be used to interact with and select various functions that appear on the display 28.

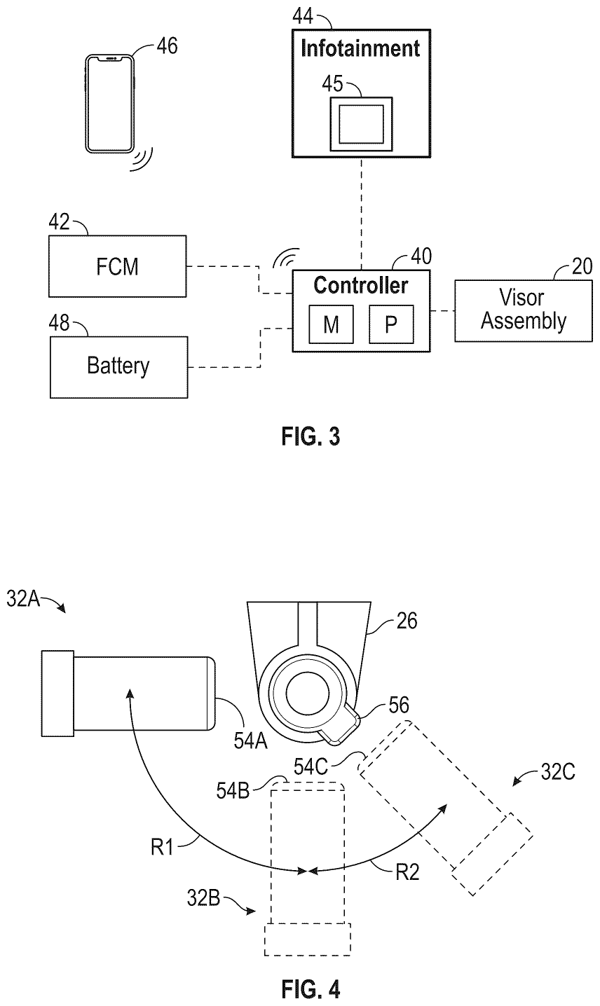

As shown in FIG. 3 and with continued reference to FIG. 2, the visor assembly 20 can be in direct electrical communication or through a wireless connection, such as Bluetooth or Wi-Fi, with other components on or around the vehicle 10. In particular, the visor assembly 20 is in electrical communication with a controller 40. In one example, the controller 40 can be integrated directly into the visor assembly 20 or the controller 40 can be located remote from the visor assembly 20 but within the vehicle 10. In particular, the controller 40 could include a portion of an electronic control unit (“ECU”) on the vehicle 10. In the illustrated example, the controller 40 is also in electrical communication with an infotainment system 44 having a user interactive display 45, a front camera module 42 having at least one camera for viewing an area surrounding the vehicle 10, and a battery 48 for powering at least one of the controller 40 or the visor assembly 20. The controller 40 can also form a wireless connection with a mobile device 46, such as a cellular phone or tablet, to interface the visor assembly 20 and provide messages to display on the display 28.

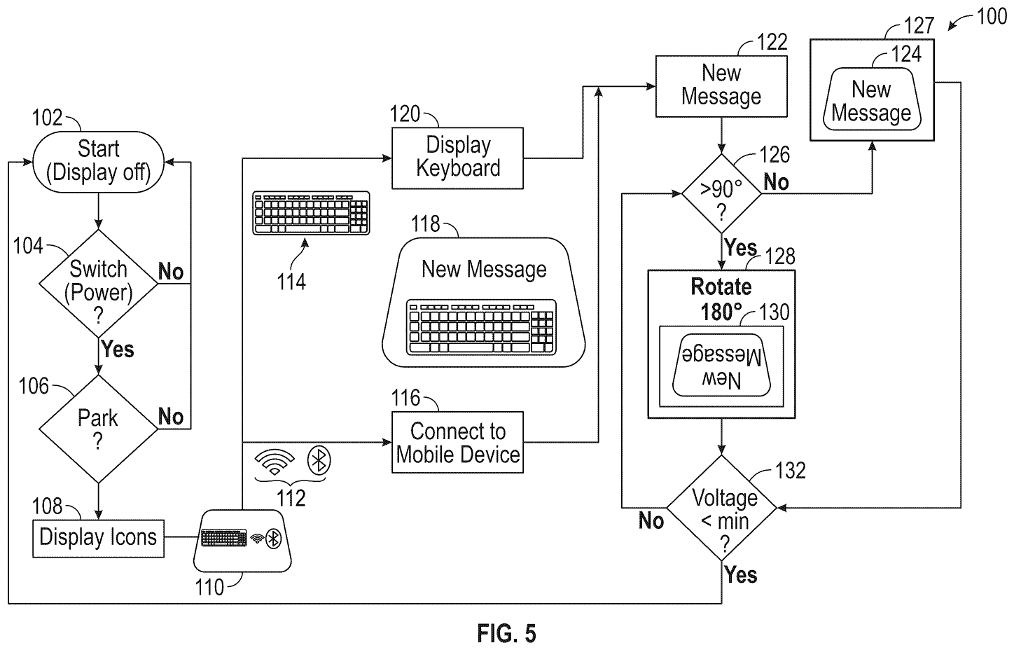

The controller 40 may alternatively be referred to as a control module, a control unit, an electronic controller, a vehicle 10 controller, a computer, etc. The controller 40 may include a computer and/or processor, and include software, hardware, memory M, algorithms, connections, etc., for managing and controlling the operation of visor assembly 20 and/or the vehicle 10. As such, a method 100, described below and generally represented in FIG. 5, may be embodied as a program or algorithm partially operable on the controller 40. It should be appreciated that the controller 40 may include a device capable of analyzing data from the sensor 32, comparing data, making the decisions required to control the operation of visor assembly 20 and/or the vehicle 10, and executing the required tasks to control the operation thereof.

The controller 40 may be embodied as one or multiple digital computers or host machines each having one or more processors P, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and input/output (I/O) circuitry, I/O devices, and communication interfaces, as well as signal conditioning and buffer electronics. The computer-readable memory may include non-transitory/tangible medium which participates in providing data or computer-readable instructions that are executed by the processor P. Memory may be non-volatile or volatile. Non-volatile media may include, for example, optical or magnetic disks and other persistent memory. Example volatile media may include dynamic random-access memory (DRAM), which may constitute a main memory. Other examples of embodiments for memory include a flexible disk, hard disk, magnetic tape or other magnetic medium, a CD-ROM, DVD, and/or other optical medium, as well as other possible memory devices such as flash memory.

FIG. 5 illustrates a flow diagram of an example method 100 of operating the visor assembly 20. In the illustrated example, the method 100 starts at block 102 (“Start (Display Off)”). From block 102, the method 100 proceeds to block 104.

At block 104 (“Switch (Power)”), the method 100 determines if the power switch 50 on the input 30 has been placed into an active position to power the visor assembly 20. If the power switch 50 has not been placed in an active position, the method 100 returns to block 102 and continues to monitor for the power switch 50 on the input 30 being placed into the active position. If the method determines that the power switch 50 has been placed into the active position, the method 100 proceeds to block 106.

At block 106 (“Park?”), the method 100 determines if the vehicle 10 is in a parked position. In one example, the parked position can correspond to a drivetrain of the vehicle 10 being placed in a locked position to prevent movement of the vehicle 10. If the vehicle 10 is not in park, the method 100 will return to block 102 and continue to monitor for the power switch 50 being activated and the vehicle 10 being in park. This disclosure contemplates situations where the display 28 will only be activated when the vehicle 10 is in park. However, it is possible for the method 100 to bypass block 106 if a desired message to be shared on the display 28 is relevant while the vehicle 10 is in motion, such as may be applicable to ride shares or taxis. As shown in the illustrated example, the method 100 proceeds to block 108 when the vehicle 10 is in a parked position.

At block 108 (“Display Icons”), the method 100 generates an image 110 having various icons to select regarding inputting a message to be displayed. In one example, the image 110 can include an icon for a keyboard, a wireless connection (e.g. Wi-fi), or a Bluetooth connection. The image 110 can be sent by the controller 40 through control signals to the display 45 on the infotainment system 44 or through control signals to the display 28 on the visor assembly 20. In one example, the displays 28 and 45 can be touch screen displays that allow a user to select a desired connection type by pressing or contacting a portion of the display corresponding to the desired connection type. Alternatively, the dial 52 on the input 30 or an input on the infotainment system 44 can be used to highlight and select the desired connection type. Once the desired connection type has been selected, the method 100 proceeds to one of block 116 or block 120 depending on the selection choice.

The method 100 proceeds to block 116 (“Connect to Mobile Device”), if one of the wireless icons 112 were selected. The method 100 can then form a wireless connection with the mobile device 46 as shown in FIG. 3. The wireless connection with the mobile device 46 allows the controller 40 to receive input from a user that will form a new message to display on the display 28. In one example, the new message is selected from a list of predetermined messages and in another example, the new message is customized by the user and entered through the mobile device 46.

Similarly, the method 100 proceeds to block 120 (“Display Keyboard”), if the keyboard icon 114 was selected. The method 100 can then display a keyboard on one of the displays 28 or 45. The user can then interact with one of the displays 28 or 45 to generate the desired new message or select a predetermined new message. With the desired new message input or selected through one of the blocks 116 or 120, the method 100 then proceeds to block 122.

At block 122 (“New Message”), the method 100 generates the desired output message from the inputs provided by the user from one of the blocks 116 or 120. However, prior to displaying the new message on the display 28, an orientation of the body portion 22 relative to the mounting assembly 24 is determined. This determination is used to select a predetermined orientation to display the new message on the display 28, the method 100 then proceeds to block 126.

At block 126 (“>90°”), the method 100 determines if the body portion 22 is located in a rotational position that is greater than 90 degrees relative to the mounting assembly 24. The method 100 determines the relative position of the body portion 22 relative to the mounting assembly 24 with the sensor 32 and the indicator 34. As shown in FIG. 4, as the sensor 32, which is fixed to the body portion 22, pivots about the arm 26 of the mounting assembly 24, a distance between a distal end 54A of the sensor 32 and the indicator 34 varies. In the illustrated example shown in FIG. 4, the increased distance between the sensor 32 and the indicator 34 corresponds to the body portion 22 being at less than or equal to 90 degrees relative to the mounting portion 24. A rotational range R1 shown between the sensor 32A and a sensor position 32B with distal end 54B corresponds to the body portion 22 being equal to or less than 90 degrees relative to the mounting assembly 24. When the sensor is pivoted between the sensor positions 32B and 32C, with distal end 54C, this corresponds to a rotational range R2 of the sensor with the body portion 22 being positioned at greater than 90 degrees relative to the mounting assembly 24.

If the body portion 22 is positioned at less than or equal to 90 degrees relative to the mounting assembly 24, the method 100 proceeds to block 127 and displays the new message in a first orientation 124. When the new message is displayed in the first orientation 124, the method 100 then proceeds to block 132 to determine if a battery voltage of the vehicle 10 is less than a minimum threshold battery voltage. If the battery voltage for the vehicle 10 is less than the minimum threshold battery voltage, the method 100 returns to block 102 and turns the display 28 off. If the battery voltage is not less than the minimum threshold battery voltage, the method 100 returns to block 126 to continue monitoring the rotational position of the body portion 22.

If the body portion 22 is at a rotational position greater than 90 degrees, the method 100 then proceeds to block 128 from block 126. At block 128 (“Rotate 180°”), the new message is displayed in a second orientation 130. The second orientation 130 of the new message is rotated 180 degrees relative to the first orientation 124 of the new message. One feature of this disclosure is to present the new message in an orientation that is easily readable by the intended audience. For example, when the body portion 22 is in a fully stowed position and up to rotating through to 90 degrees, the new message remains in the first orientation 124 so that the occupant of the vehicle 10 can read the new message. Conversely, when the body portion 22 exceeds 90 degrees, the new message is rotated to the second orientation 130 to allows people outside of the vehicle 10 to easily read the new message without the text of the new message appearing upside down. From block 128, the method 100 proceeds to block 132.

At block 132, the method 100 performs the minimum threshold battery voltage check as outlined above and either turns the display 28 off by proceeding to block 102 and end the method 100 or continues to monitor the rotational position of the body portion 22 by returning to block 126.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in a suitable manner in the various aspects.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the scope thereof. Therefore, it is intended that the present disclosure is not limited to the particular embodiments disclosed but will include embodiments falling within the scope thereof.

What is claimed is:

1. A visor assembly, comprising:
a mounting assembly including a base portion and an arm extending from the base portion;
a body portion rotatably attached to the arm of the mounting assembly, wherein the body portion includes a first side located opposite a second side;
a display located adjacent to one of the first side or the second side of the body portion;
a sensor assembly configured to determine a position of the body portion relative to the mounting assembly; and
a controller in communication with the display and the sensor assembly, wherein the controller is configured to:
determine a message to display on the display;
determine a position of the body portion relative to the mounting assembly with the sensor assembly; and
display the message on the display in a predetermined orientation based on the position of the body portion relative to the mounting assembly.

2. The visor assembly of claim 1, including an input located on the body portion including a switch configured to activate the display and a dial configured to vary a brightness of the display.

3. The visor assembly of claim 1, wherein the controller is located within the body portion.

4. The visor assembly of claim 1, wherein the sensor assembly includes a hall sensor located on one of the body portion and the arm and an indicator located on the other of the body portion and the mounting assembly.

5. The visor assembly of claim 4, wherein the hall sensor is fixed relative to the body portion and the indicator is fixed relative to the arm.

6. The visor assembly of claim 5, wherein the indicator is cylindrical and includes a projection extending radially outward therefrom and at least a portion of the indicator is comprised of steel.

7. The visor assembly of claim 1, wherein the controller is configured to receive wireless signals from a mobile device to determine the message.

8. The visor assembly of claim 1, wherein the controller is configured to receive input signals from an infotainment system on a vehicle to determine the message.

9. The visor assembly of claim 1, wherein the display is a touchscreen display.

10. A vehicle, comprising:
a passenger cabin supported by a plurality of wheels; and
at least one visor assembly located within the passenger cabin, wherein the at least one visor assembly includes:
a mounting assembly including a base portion and an arm extending from the base portion;
a body portion rotatably attached to the arm of the mounting assembly, wherein the body portion includes a first side located opposite a second side;
a display located adjacent to one of the first side or the second side of the body portion;
a sensor assembly configured to determine a position of the body portion relative to the mounting assembly; and
a controller in communication with the display and the sensor assembly, wherein the controller is configured to:
determine a message to display on the display;
determine a position of the body portion relative to the mounting assembly with the sensor assembly; and
display the message on the display in a predetermined orientation based on the position of the body portion relative to the mounting assembly.

11. The vehicle of claim 10, including an input located on the body portion including a switch configured to activate the display and a dial configured to vary a brightness of the display.

12. The vehicle of claim 10, wherein the controller is located within the body portion.

13. The vehicle of claim 10, wherein the sensor assembly includes a hall sensor located on one of the body portion and the arm and an indicator located on the other of the body portion and the mounting assembly.

14. The vehicle of claim 13, wherein the hall sensor is fixed relative to the body portion and the indicator is fixed relative to the arm.

15. The vehicle of claim 10, wherein a controller configured to receive wireless signals from a mobile device to determine the message.

16. The vehicle of claim 10, wherein the controller is configured to receive input signals from an infotainment system on a vehicle to determine the message.

17. A method of operating a visor assembly of a vehicle, the method comprising:
determining a message to display on a display of the visor assembly, wherein the visor assembly includes:
a mounting assembly including a base portion and an arm extending from the base portion;
a body portion rotatably attached to the arm, wherein the body portion includes a first side located opposite a second side with the display located on one of the first side or the second side; and
a sensor assembly configured to determine a position of the body portion relative to the mount assembly;
determining a position of the body portion relative to the mounting assembly with the sensor assembly; and
displaying the message on the display in a predetermined orientation based on the position of the body portion relative to the mounting assembly.

18. The method of claim 17, including determining an operational state of the vehicle and activating the display based on the operational state of the vehicle.

19. The method of claim 17, including determining a battery voltage level of a vehicle battery and directing the display into an off mode when the battery voltage level is below a predetermined threshold battery voltage level.

20. The method of claim 17, including determining if a person is within a predetermined distance of the vehicle by identifying a person with a camera system on the vehicle, wherein the message is displayed on the display when the person is within the predetermined distance of the vehicle.
